(19) United States
(12) Patent Application Publication
(10) Pub. No.: US 2025/0055213 A1
(43) Pub. Date: Feb. 13, 2025

(54) CARD EDGE CONNECTOR

(71) Applicants: TE Connectivity Solutions GmbH, Schaffhausen (CH); TE CONNECTIVITY INDIA PRIVATE LIMITED, Bangalore (IN)

(72) Inventors: Jared Evan Rossman, York Haven, PA (US); Brian Patrick Costello, Athens, GA (US); Rakesh K., Bangalore (IN); Michael John Phillips, Camp Hill, PA (US)

(21) Appl. No.: 18/644,426

(22) Filed: Apr. 24, 2024

Related U.S. Application Data
(60) Provisional application No. 63/518,340, filed on Aug. 9, 2023.

(51) Int. Cl. H01R 12/72; H01R 13/6585

(52) U.S. Cl. CPC H01R 12/727; H01R 12/721; H01R 13/6585

(57) ABSTRACT

A contact assembly includes a contact holder having a central wall separating walls extending from a surface of the central wall defining contact tracks along the surface. A contact array is coupled to the surface and includes inner contacts arranged in pairs with contact dielectric bodies encapsulating portions of corresponding pairs of the contacts. Each pair of the contacts and the corresponding contact dielectric bodies form a contact set. The contact dielectric bodies of each contact set is spaced apart from each other and received in the corresponding contact track with the separating walls separating the contact sets from each other. A shield is coupled to the contact holder to cover the contact tracks and form shield pockets surrounding the corresponding contact tracks to provide circumferential shielding for the corresponding contact sets.

### CROSS REFERENCE TO RELATED APPLICATIONS

This application claims benefit to U.S. Provisional Application No. 63/518,340, filed 14 Aug. 2023, titled “CARD EDGE CONNECTOR”, the subject matter of which is herein incorporated by reference in its entirety.

### BACKGROUND OF THE INVENTION

The subject matter herein relates generally to card edge connectors of communication systems.

Some communication systems utilize communication connectors, such as card edge connectors to interconnect various components of the system for data communication. Some known communication systems use pluggable module, such as I/O modules or circuit cards, which are electrically connected to the card edge connectors. The pluggable module has module circuit boards having card edges that are mated with the card edge connectors during the mating operation. Each card edge connector typically has an upper row of contacts and a lower row of contacts for mating with the corresponding circuit board. There is a need for connectors and circuit boards of communication systems to have greater contact density and/or data throughput. Known card edge connectors are not without disadvantages. For instance, large sections of the contacts are typically rigidly fixed within the connector housing, such as using a contact overmold to hold the contacts relative to each other and relative to the housing. The overmold may negatively affect the electrical characteristics of the signal transmission lines. For example, the plastic material of the overmold creates a path for cross talk between the signal contacts. Properly shielding the signal transmission lines is problematic. Additionally, properly positioning the mating ends and the terminating ends of all of the contacts is difficult to control.

A need remains for a reliable card edge connector to carry high speed signals.

### BRIEF DESCRIPTION OF THE INVENTION

In one embodiment, a contact assembly is provided and includes a contact holder having a central wall with an inner surface and an outer surface. The central wall has a front edge between the inner surface and the outer surface. The central wall has a board end between the inner surface and the outer surface configured to face a circuit board. The contact holder includes inner separating walls extending from the inner surface of the central wall and defining inner contact tracks along the inner surface. The contact holder includes outer separating walls extending from the outer surface of the central wall and defining outer contact tracks along the outer surface. The contact holder is electrically conductive to provide electrical shielding between the inner contact tracks and the outer contact tracks. The contact assembly includes an inner contact array coupled to the inner surface of the contact holder. The inner contact array includes inner contacts arranged in pairs. The inner contact array includes inner contact dielectric bodies encapsulating portions of corresponding pairs of the inner contacts. Each pair of the inner contacts and the corresponding inner contact dielectric bodies form an inner contact set. The inner contact dielectric bodies of each inner contact set is spaced apart from each other. The inner contact sets are received in corresponding inner contact tracks with the inner separating walls separating the inner contact sets from other inner contact sets. The contact assembly includes an outer contact array coupled to the outer surface of the contact holder. The outer contact array includes outer contacts arranged in pairs. The outer contact array includes outer contact dielectric bodies encapsulating portions of corresponding pairs of the outer contacts. Each pair of the outer contacts and the corresponding outer contact dielectric bodies form an outer contact set. The outer contact dielectric bodies of each outer contact set are spaced apart from each other. The outer contact sets are received in corresponding outer contact tracks with the outer separating walls separating the outer contact sets from other outer contact sets. The contact assembly includes an inner shield coupled to the contact holder to cover the inner contact tracks. The central wall, the separating walls, and the inner shield form shield pockets surrounding the corresponding inner contact tracks to provide circumferential shielding for the corresponding inner contact sets. The contact assembly includes an outer shield coupled to the contact holder to cover the outer contact tracks. The central wall, the separating walls, and the outer shield form shield pockets surrounding the corresponding outer contact tracks to provide circumferential shielding for the corresponding outer contact sets.

In another embodiment, a card edge connector for mating with a pluggable module is provided. The card edge connector includes a housing including a top and a bottom. The housing has a front and a rear. The housing has a first side and a second side. The bottom is configured to be mounted to a circuit board. The housing includes a cavity at the rear. The housing includes a card slot open to the cavity at the front of the housing. The card slot is configured to receive a card edge of a module circuit board of the pluggable module. The card edge connector includes a contact assembly received in the cavity. The contact assembly has a contact holder holding an inner contact array and an outer contact array. The contact array includes an inner shield coupled to the contact holder and an outer shield coupled to the contact holder. The contact holder has central wall with an inner surface and an outer surface. The central wall has a front edge between the inner surface and the outer surface configured to face the card edge of the module circuit board. The central wall has a board end between the inner surface and the outer surface configured to face the circuit board. The contact holder includes inner separating walls extending from the inner surface of the central wall and defining inner contact tracks along the inner surface. The contact holder includes outer separating walls extending from the outer surface of the central wall and defining outer contact tracks along the outer surface. The contact holder is electrically conductive to provide electrical shielding between the inner contact tracks and the outer contact tracks. The inner contact array is coupled to the inner surface of the contact holder. The inner contact array includes inner contacts arranged in pairs. The inner contacts include mating beams extending from the contact holder into the card slot to mate with the module circuit board. The inner contact array includes inner contact dielectric bodies encapsulating portions of corresponding pairs of the inner contacts. Each pair of the inner contacts and the corresponding inner contact dielectric bodies form an inner contact set. The inner contact dielectric bodies of each inner contact set is spaced apart from each other. The inner contact sets are received in corresponding inner contact tracks with the inner separating walls separating the inner contact sets from other inner contact sets. The outer contact array is coupled to the outer surface of the contact holder. The outer contact array includes outer contacts arranged in pairs. The inner contacts include mating beams extending from the contact holder into the card slot to mate with the module circuit board. The outer contact array includes outer contact dielectric bodies encapsulating portions of corresponding pairs of the outer contacts. Each pair of the outer contacts and the corresponding outer contact dielectric bodies form an outer contact set. The outer contact dielectric bodies of each outer contact set are spaced apart from each other. The outer contact sets are received in corresponding outer contact tracks with the outer separating walls separating the outer contact sets from other outer contact sets. The inner shield is coupled to the contact holder to cover the inner contact tracks. The central wall, the separating walls, and the inner shield form shield pockets surrounding the corresponding inner contact tracks to provide circumferential shielding for the corresponding inner contact sets. The outer shield is coupled to the contact holder to cover the outer contact tracks. The central wall, the separating walls, and the outer shield form shield pockets surrounding the corresponding outer contact tracks to provide circumferential shielding for the corresponding outer contact sets.

In a further embodiment, a receptacle connector assembly for connecting a pluggable module with a circuit board is provided. The receptacle connector includes a receptacle cage having walls forming a module channel configured to receive the pluggable module and a port open to the module channel. The receptacle connector includes a card edge connector configured to be mounted to the circuit board. The card edge connector is received in the module channel for mating with the pluggable module. The card edge connector includes a housing and a contact assembly received in the housing. The housing includes a top and a bottom. The housing has a front and a rear. The housing has a first side and a second side. The bottom configured to be mounted to a circuit board. The housing includes a cavity at the rear. The housing includes a card slot open to the cavity at the front of the housing. The card slot is configured to receive a card edge of a module circuit board of the pluggable module. The contact assembly received in the cavity. The contact assembly has a contact holder holding an inner contact array and an outer contact array. The contact array includes an inner shield coupled to the contact holder and an outer shield coupled to the contact holder. The contact holder has central wall with an inner surface and an outer surface. The central wall has a front edge between the inner surface and the outer surface configured to face the card edge of the module circuit board. The central wall has a board end between the inner surface and the outer surface configured to face the circuit board. The contact holder includes inner separating walls extending from the inner surface of the central wall and defining inner contact tracks along the inner surface. The contact holder includes outer separating walls extending from the outer surface of the central wall and defining outer contact tracks along the outer surface. The contact holder is electrically conductive to provide electrical shielding between the inner contact tracks and the outer contact tracks. The inner contact array is coupled to the inner surface of the contact holder. The inner contact array includes inner contacts arranged in pairs. The inner contacts include mating beams extending from the contact holder into the card slot to mate with the module circuit board. The inner contact array includes inner contact dielectric bodies encapsulating portions of corresponding pairs of the inner contacts. Each pair of the inner contacts and the corresponding inner contact dielectric bodies form an inner contact set. The inner contact dielectric bodies of each inner contact set is spaced apart from each other. The inner contact sets are received in corresponding inner contact tracks with the inner separating walls separating the inner contact sets from other inner contact sets. The outer contact array coupled to the outer surface of the contact holder. The outer contact array includes outer contacts arranged in pairs. The inner contacts include mating beams extending from the contact holder into the card slot to mate with the module circuit board. The outer contact array includes outer contact dielectric bodies encapsulating portions of corresponding pairs of the outer contacts. Each pair of the outer contacts and the corresponding outer contact dielectric bodies form an outer contact set. The outer contact dielectric bodies of each outer contact set are spaced apart from each other. The outer contact sets are received in corresponding outer contact tracks with the outer separating walls separating the outer contact sets from other outer contact sets. The inner shield coupled to the contact holder to cover the inner contact tracks. The central wall, the separating walls, and the inner shield form shield pockets surrounding the corresponding inner contact tracks to provide circumferential shielding for the corresponding inner contact sets. The outer shield coupled to the contact holder to cover the outer contact tracks. The central wall, the separating walls, and the outer shield form shield pockets surrounding the corresponding outer contact tracks to provide circumferential shielding for the corresponding outer contact sets.

### BRIEF DESCRIPTION OF THE DRAWINGS

FIG. 1 is a front perspective view of a communication system in accordance with an exemplary embodiment.

FIG. 2 is a front perspective view of a portion of the communication system in accordance with an exemplary embodiment.

FIG. 3 is a front perspective view of the card edge connector in accordance with an exemplary embodiment.

FIG. 4 is a rear perspective view of the card edge connector in accordance with an exemplary embodiment.

FIG. 5 is a bottom perspective view of the card edge connector in accordance with an exemplary embodiment.

FIG. 6 is a rear perspective view of the contact assembly in accordance with an exemplary embodiment.

FIG. 7 is a rear perspective view of the contact holder in accordance with an exemplary embodiment.

FIG. 8 is an exploded view of a portion of the contact assembly in accordance with an exemplary embodiment.

FIG. 9 is a rear perspective, assembled view of a portion of the contact assembly in accordance with an exemplary embodiment.

FIG. 10 is a top view of a portion of the contact assembly in accordance with an exemplary embodiment.

FIG. 11 is a cross sectional view of a portion of the contact assembly in accordance with an exemplary embodiment.

FIG. 12 is an enlarged cross-sectional view of a portion of the contact assembly in accordance with an exemplary embodiment.

FIG. 13 is a cross sectional view of a portion of the communication system showing the pluggable module coupled to the receptacle connector assembly in accordance with an exemplary embodiment.

### DETAILED DESCRIPTION OF THE INVENTION

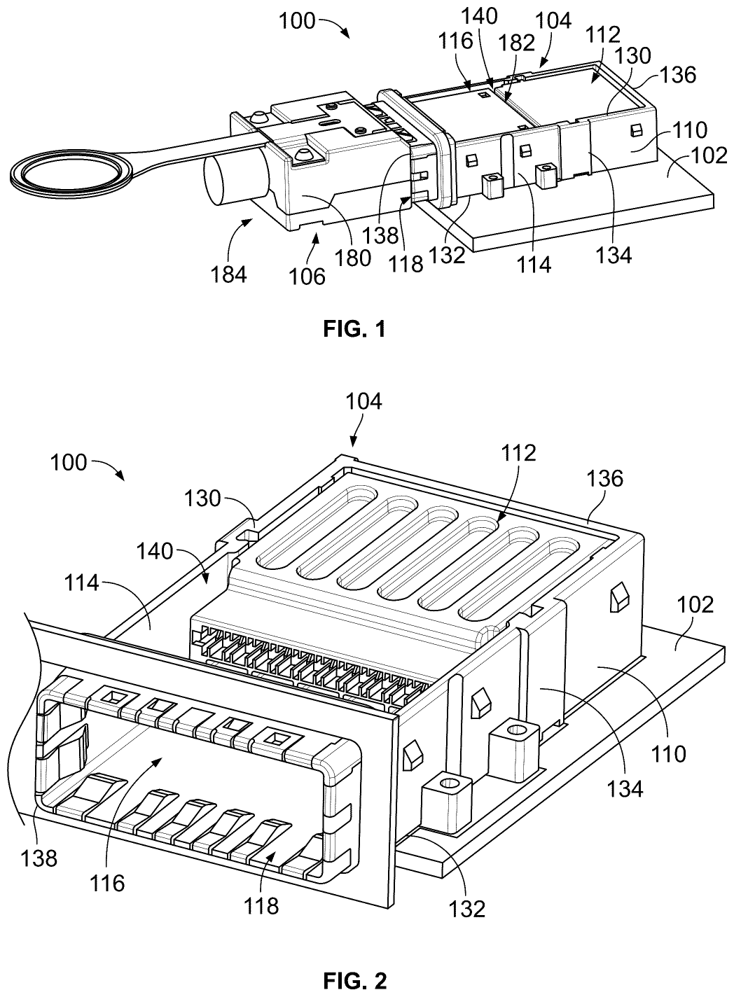

FIG. 1 is a front perspective view of a communication system 100 in accordance with an exemplary embodiment. FIG. 2 is a front perspective view of a portion of the communication system 100 in accordance with an exemplary embodiment. The communication system 100 includes a circuit board 102 and a receptacle connector assembly 104 mounted to the circuit board 102. A pluggable module 106 (FIG. 1) is configured to be electrically connected to the receptacle connector assembly 104. The pluggable module 106 is removed in FIG. 2 to illustrate components of the receptacle connector assembly 104. The pluggable module 106 is electrically connected to the circuit board 102 through the receptacle connector assembly 104.

In an exemplary embodiment, the receptacle connector assembly 104 includes a receptacle cage 110 and an electrical connector assembly 112 adjacent the receptacle cage 110. For example, in the illustrated embodiment, the electrical connector assembly 112 is received in the receptacle cage 110. In other various embodiments, the electrical connector assembly 112 may be located rearward of the receptacle cage 110. In various embodiments, the electrical connector assembly 112 is a card edge connector and may be referred to hereinafter as a card edge connector 112.

In various embodiments, the receptacle cage 110 is enclosed and provides electrical shielding for the electrical connector assembly 112. The pluggable module 106 is loaded into the receptacle cage 110 and is at least partially surrounded by the receptacle cage 110. The receptacle cage 110 includes a plurality of walls 114 that define one or more module channels for receipt of corresponding pluggable module(s) 106. The walls 114 may be walls defined by solid sheets, perforated walls to allow airflow therethrough, walls with cutouts, such as for a heatsink or heat spreader to pass therethrough, or walls defined by rails or beams with relatively large openings. In an exemplary embodiment, the receptacle cage 110 is a shielding, die cast metallic cage member with the walls 114 being shielding walls 114. In other embodiments, the receptacle cage 110 may be open between frame members, such as rails or beams, to provide cooling airflow for the pluggable module 106 with the frame members of the receptacle cage 110 defining guide tracks for guiding loading of the pluggable module 106 into the receptacle cage 110.

In the illustrated embodiment, the receptacle cage 110 is a single port cage configured to receive a single pluggable module 106 in a single module channel 116. However, in alternative embodiments, the receptacle cage 110 may include multiple ports to receive multiple pluggable modules, such as being a stacked cage member having upper and lower module channels 116. The module channels may be arranged in a single column, however, the receptacle cage 110 may include multiple columns of ganged module channels in alternative embodiments (for example, 2×2, 3×2, 4×2, 4×3, etc.). The receptacle cage 110 includes a port 118 providing access to the module channel 116. The pluggable module 106 is plugged into the module channel 116 through the port 118. Optionally, multiple electrical connector assemblies 112 may be arranged within the receptacle cage 110 to mate with the multiple pluggable modules.

In an exemplary embodiment, the walls 114 of the receptacle cage 110 include a top wall 130, a bottom wall 132, and side walls 134 extending between the top wall 130 and the bottom wall 132. The bottom wall 132 may rest on the circuit board 102. However, in alternative embodiments, the bottom wall 132 may be elevated a distance above the circuit board 102 defining a gap below the bottom wall 132, such as for airflow. In other various embodiments, the receptacle cage 110 may be provided without the bottom wall 132. Optionally, the walls 114 of the receptacle cage 110 may include a rear wall 136 and a front wall 138 at the front of the receptacle cage 110. The module port 118 is provided in the front wall 138. The walls 114 define a cavity 140, which forms the module channel(s) 116. The cavity 140 is defined by the top wall 130, the bottom wall 132, the side walls 134, the rear wall 136 and the front wall 138. Other walls 114 may separate or divide the cavity 140 into various module channels 116. For example, the walls 114 may include a channel separator between upper and lower module channels 116. The walls 114 may include divider walls, parallel to the side walls 134, extending between the top wall 130 and the bottom wall 132 to separate adjacent module channels from each other.

In an exemplary embodiment, the receptacle cage 110 may include one or more gaskets at the front wall 138 for providing electrical shielding for the module channel 116. For example, the gaskets may be configured to electrically connect with the pluggable module 106 received in the module channel 116. The gaskets may be configured to electrically connect to a panel or bezel.

In an exemplary embodiment, the receptacle connector assembly 104 may include one or more heat sinks (not shown) for dissipating heat from the pluggable module 106. For example, the heat sink may be coupled to the top wall 130 and extend through an opening in the top wall 130 to engage the pluggable module 106 and dissipate heat from the pluggable module 106.

In an exemplary embodiment, the electrical connector assembly 112 is received in the cavity 140, such as proximate to the rear wall 136. However, in alternative embodiments, the electrical connector assembly 112 may be located behind the rear wall 136 exterior of the receptacle cage 110 and extend into the cavity 140 to interface with the pluggable module(s) 106. In an exemplary embodiment, a single electrical connector assembly 112 is used. However, multiple electrical connector assemblies 112 may be used in other embodiments.

In an exemplary embodiment, the pluggable module 106 is loaded through the front wall 138 to mate with the electrical connector assembly 112. The shielding walls 114 of the receptacle cage 110 provide electrical shielding around the electrical connector assembly 112 and the pluggable module 106, such as around the mating interfaces between the electrical connector assembly 112 and the pluggable module 106.

In an exemplary embodiment, the pluggable module 106 is an input/output (I/O) module, such as a transceiver module. The pluggable module 106 includes a pluggable body 180, which may be defined by one or more shells. The pluggable body 180 may be thermally conductive and/or may be electrically conductive, such as to provide EMI shielding for the pluggable module 106. The pluggable body 180 includes a mating end 182 plugged into the receptacle cage 110 and a cable end 184 opposite the mating end 182. The pluggable body 180 holds one or more module circuit boards 190 (shown in FIG. 13) that is/are configured to be communicatively coupled to the electrical connector assembly 112. The module circuit boards 190 are accessible at the mating end 182 for mating with the electrical connector assembly 112. The module circuit board 190 has a card edge configured to be plugged into a card slot of the electrical connector assembly 112 and contacts, such as pads or circuits, at the card edge configured to be mated with the card edge connector 112.

In other various embodiments, the pluggable module 106 may be a circuit card or paddle card rather than an I/O module. For example, the pluggable module 106 may include the module circuit board 190 without the pluggable body 180 surrounding the module circuit board 190.

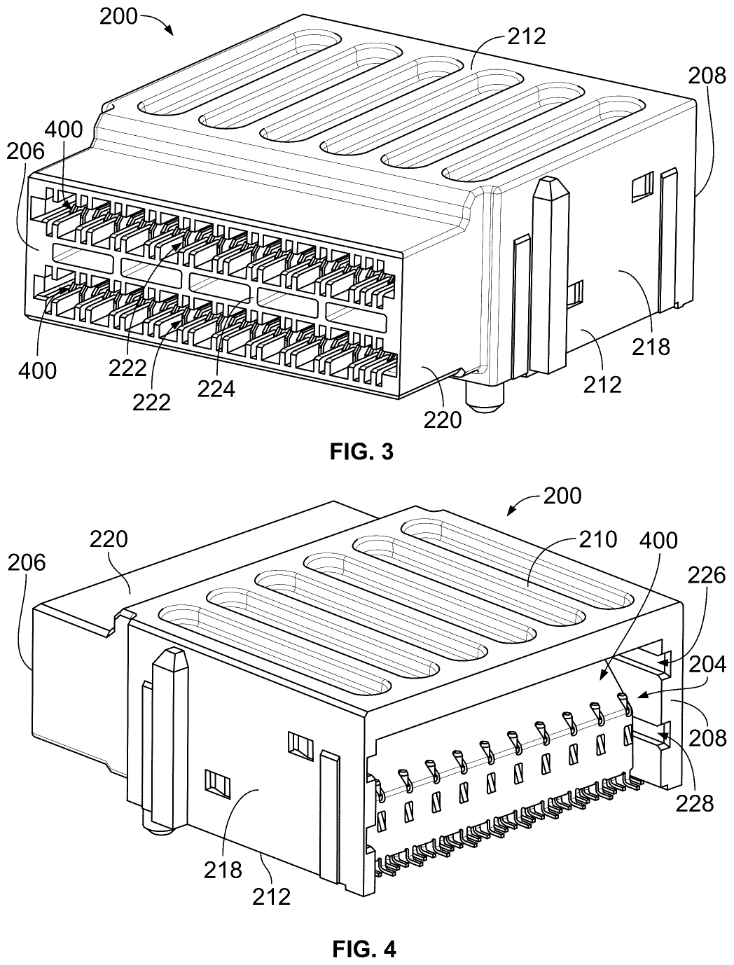

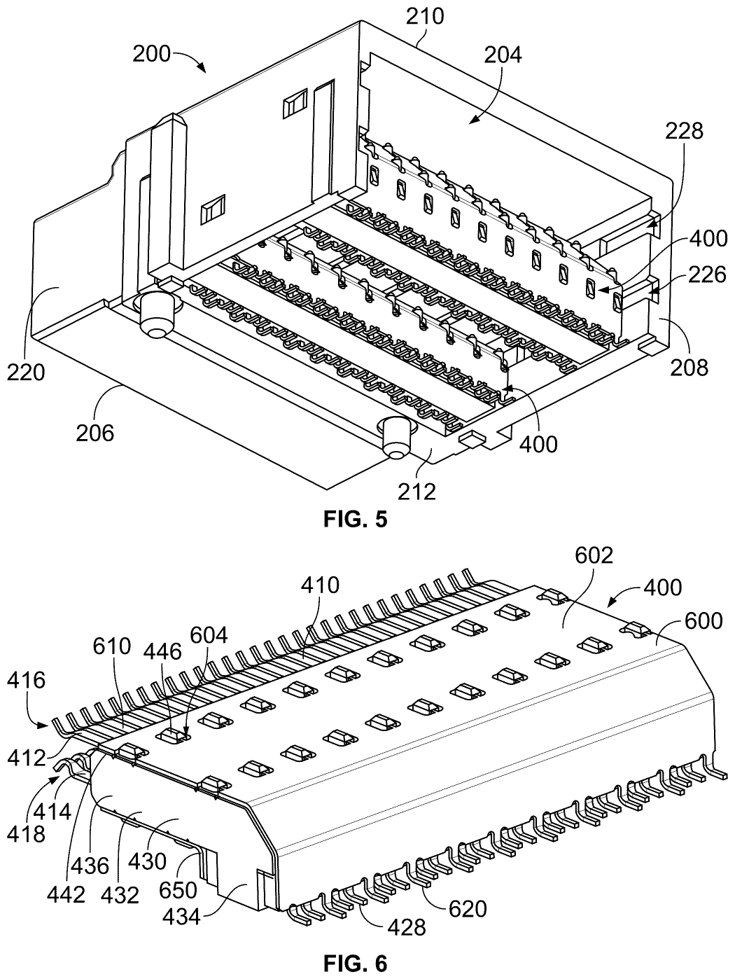

FIG. 3 is a front perspective view of the card edge connector 112 in accordance with an exemplary embodiment. FIG. 4 is a rear perspective view of the card edge connector 112 in accordance with an exemplary embodiment. FIG. 5 is a bottom perspective view of the card edge connector 112 in accordance with an exemplary embodiment. The card edge connector 112 includes a housing 200 having a cavity 204 and a contact assembly 400 received in the cavity 204 of the housing 200.

The housing 200 extends between a front 206 and a rear 208. The cavity 204 is open at the rear 208 to receive the contact assembly 400. The housing 200 extends between a top 210 and a bottom 212. The housing 200 extends between opposite sides 218. The housing 200 may be generally box shaped in various embodiments. In the illustrated embodiment, the bottom 212 defines a mounting end configured to be mounted to the circuit board 102 (shown in FIG. 1) and the front 206 defines the mating end configured to be mated with the pluggable module 106 (shown in FIG. 1). Other orientations are possible in alternative embodiments, such as with the mating end at the top 210 and/or the mounting end at the rear 208.

The housing 200 includes a shroud 220 at the mating end, such as at the front 206. The shroud 220 is configured to be received in the pluggable module 106 (FIG. 1) when the pluggable module 106 is mated with the electrical connector assembly 112. The housing 200 includes one or more card slots 222 surrounded by the shroud 220. In the illustrated embodiment, the housing 200 includes two of the card slots 222, such as an upper card slot and a lower card slot. The shroud 220 includes a separating wall 224 between the card slots 222. The card slots 222 receive the card edges of the module circuit boards 190 (shown in FIG. 13) on opposite sides of the separating wall 224. The contact assembly 400 is received in the housing 200 at the card slots 222 to mate with the module circuit boards 190.

In an exemplary embodiment, the contact assembly 400 includes a subassembly associated with each of the card slots 222. For example, a lower contact assembly is received in the lower portion of the housing 200 and an upper contact assembly is received in the upper portion of the housing 200. For example, the lower contact assembly is received in the cavity 204 aligned with and extending into the lower card slot and the upper contact assembly is received in the cavity 204 aligned with and extending into the upper card slot. The lower contact assembly may be similar to the upper contact assembly and include similar components, which may be sized and shaped differently for fitting into the housing 200. The components of either contact assembly 400 may be referred to generally or may be referred to herein using identifiers “lower” or “upper”. The housing 200 includes guide features 226 to guide the contact assemblies 400 into the housing 200. For example, the guide features 226 may be guide slots 228 extending along the sides 218 for loading the contact assemblies 400 into the cavity 204 of the housing 200.

FIG. 6 is a rear perspective view of the contact assembly 400 in accordance with an exemplary embodiment. In an exemplary embodiment, the contact assembly 400 is a multi-row contact assembly. For example, the contact assembly 400 may be a double-sided contact assembly 400 having contacts arranged in an upper row and a lower row. In an exemplary embodiment, the contact assembly 400 includes a contact holder 430 holding a plurality of contacts 410 including outer contacts 412 arranged in a row along the outer portion of the contact assembly 400 and inner contacts 414 arranged in a row along the inner portion of the contact assembly 400. The outer contacts 412 are arranged in an outer contact array 416 and the inner contacts 414 are arranged in an inner contact array 418. The outer contacts 412 of the outer contact array 416 may be a stamped and formed leadframe. The inner contacts 414 of the inner contact array 418 may be a stamped and formed leadframe.

The contact holder 430 may be a single piece holder, such as a single mold or die-cast component, holding both the outer contacts 412 and the inner contacts 414. The single piece holder may include one or more openings between the inner and outer surfaces, which may be air gaps or may receive portions of the housing 200. In alternative embodiments, the contact holder 430 may be a multi-piece holder, such as including an outer holder holding the outer contacts 412 and an inner holder holding the inner contacts 414. The outer holder may be coupled to the inner holder. Optionally, one or more air gaps may be provided between the outer holder and the inner holder. In various embodiments, portions of the housing 200 may be located between the outer holder and the inner holder. Alternatively, the outer holder and the inner holder may directly interface with each other. The contact holder 430 provides electrical shielding between the outer contacts 412 and the inner contacts 414. In an exemplary embodiment, the contact holder 430 provides shielding between various outer contacts 412, such as pairs of the outer contacts 412, and between various inner contacts 414, such as pairs of the inner contacts 414. The outer and inner contacts 412, 414 are configured to be arranged on opposite sides of the card slot for mating with opposite sides of the module circuit board 190 (FIG. 13). The contact assembly 400 has high density and significant data throughput. In an exemplary embodiment, the contact assembly 400 includes an outer shield 600 and an inner shield 650. The outer shield 600 provides shielding for the outer contacts 412. The inner shield 650 provides shielding for the inner contacts 414.

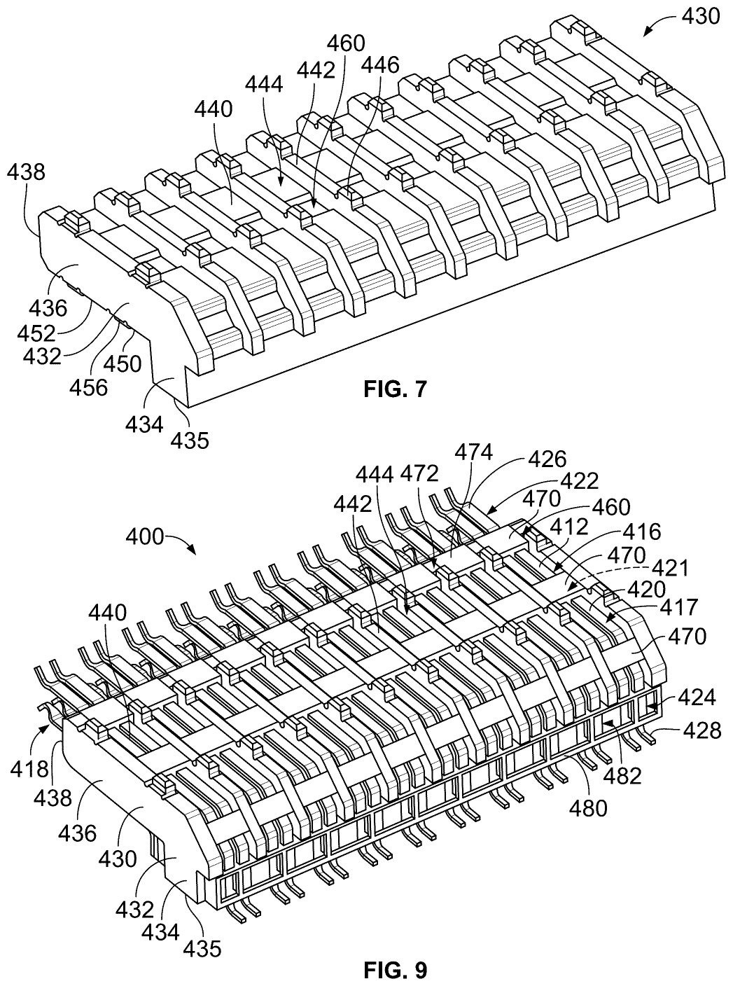

FIG. 7 is a rear perspective view of the contact holder 430 in accordance with an exemplary embodiment. The contact holder 430 is used to position the outer and inner contacts 412, 414 (FIG. 6) relative to each other. The contact holder 430 is used to hold the outer and inner contacts 412, 414 for loading into the housing 200 (shown in FIG. 4). In an exemplary embodiment, the contact holder 430 is electrically conductive to provide shielding between the various contacts 412, 414. For example, the contact holder 430 may be a die cast part or may be a plated plastic or conductive polymer.

The contact holder 430 includes a central wall 432 including a rear wall 434 and a front wall 436. The rear wall 434 extends to a bottom end 435. The bottom end 435 may be configured to face the circuit board 102 (shown in FIG. 1). The rear wall 434 may extend generally vertically. Optionally, the rear wall 434 may include a transition portion that extends between the vertical portion and the front wall 436. The front wall 436 extends forward from the rear wall 434 to a front end 438 of the contact holder 430. Optionally, the front wall 436 may extend generally horizontally. The front wall 434 may be oriented generally perpendicular to the rear wall 434.

The central wall 432 includes an outer surface 440 and an inner surface 450 opposite the outer surface 440. The outer and inner surfaces 440, 450 extend along the rear wall 434 and the front wall 436. The front end 438 extends between the outer surface 440 and the inner surface 450. The bottom end 435 extends between the outer surface 440 and the inner surface 450.

The contact holder 430 includes outer separating walls 442 extending from the outer surface 440 of the central wall 432. The outer separating walls 442 define outer contact tracks 444 therebetween along the outer surface 440. The contact holder 430 includes inner separating walls 452 extending from the inner surface 450 of the central wall 432. The inner separating walls 452 defining inner contact tracks (not shown) therebetween along the inner surface 450. The contact holder 430 is electrically conductive to provide electrical shielding between the outer contact tracks 444 and the inner contact tracks. For example, the central wall 432 provides shielding between the outer contact tracks 444 and the inner contact tracks. The outer separating walls 442 provide shielding between adjacent outer contact tracks 444. The inner separating walls 452 provide shielding between adjacent inner contact tracks. The outer separating walls 442 may be parallel to each other. The inner separating walls 452 may be parallel to each other. The outer separating walls 442 may have same heights such that distal edges of each of the outer separating walls 442 are aligned (for example, coplanar). The inner separating walls 452 may have same heights such that distal edges of each of the inner separating walls 452 are aligned (for example, coplanar).

In an exemplary embodiment, the outer separating walls 442 and the inner separating walls 452 extend along the rear wall 434 and the front wall 436. In an exemplary embodiment, the outer separating walls 442 and the inner separating walls 452 are continuous, such as from proximate to the bottom end 435 to proximate to the front end 438 to provide continuous shielding along the contact tracks. For example, the outer separating walls 442 and the inner separating walls 452 do not include breaks or openings. In various embodiments, the outer separating walls 442 and the inner separating walls 452 are continuous from the rear wall 434 all the way to the front end 438. Optionally, the outer separating walls 442 and the inner separating walls 452 may be continuous from the front wall 436 all the way to the bottom end 435.

In an exemplary embodiment, the contact holder 430 includes outer mounting posts 446 extending from the outer separating walls 442 and inner mounting posts 456 extending from the inner separating walls 452. The outer mounting posts 446 are used to mechanically and electrically connect the outer shield 600 (FIG. 6) to the contact holder 430. The inner mounting posts 456 are used to mechanically and electrically connect the inner shield 650 to the contact holder 430. Optionally, each of the separating walls 442, 452 include at least one mounting post 446, 456, respectively. The mounting posts 446, 456 may be located along the rear wall 434 and/or the front wall 436. The mounting posts 446, 456 may be rectangular, cylindrical, or have other shapes in alternative embodiments.

In an exemplary embodiment, the contact holder 430 includes dielectric body pockets 460. The dielectric body pockets 460 are provided in the outer contact tracks 444 and the inner contact tracks. For example, the contact holder 430 includes both outer dielectric body pockets and inner dielectric body pockets. The dielectric body pockets 460 may be formed in the central wall 432 and/or the separating walls 442, 452.

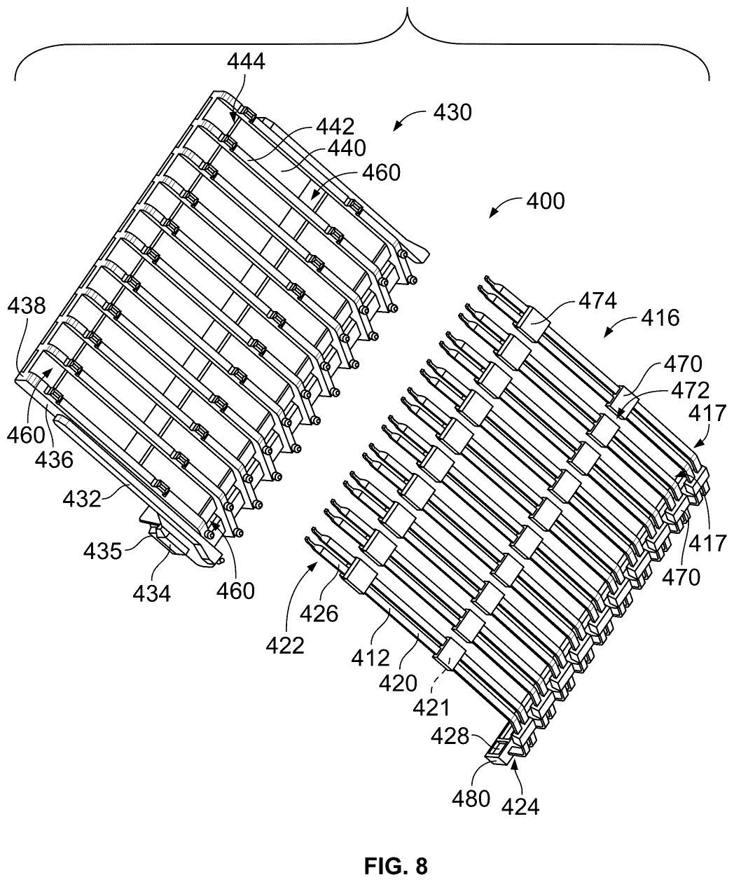

FIG. 8 is an exploded view of a portion of the contact assembly 400 in accordance with an exemplary embodiment. FIG. 9 is a rear perspective, assembled view of a portion of the contact assembly in accordance with an exemplary embodiment. FIG. 8 shows the outer contact array 416 poised for coupling to the contact holder 430. FIG. 9 shows the outer and inner contact arrays 416, 418 coupled to the contact holder 430. The central wall 432 holds the outer and inner contact arrays 416, 418. For example, the outer contact array 416 is located above the front wall 436 and rearward of the rear wall 434. The inner contact array 418 is located below the front wall 436 and forward of the rear wall 434.

In an exemplary embodiment, the inner contact array 418 is similar to the outer contact array 416 and includes similar features, which are described below with reference to the outer contact array 416. The outer contact array 416 includes a signal leadframe forming the outer contacts 412. The signal leadframe is a stamped and formed leadframe to form the outer contacts 412. The signal leadframe may be overmolded with one or more overmolded bodies to hold the relative positions of the outer contacts 412. For example, the outer contact array 416 includes a plurality of contact dielectric bodies 470 holding the corresponding outer contacts 412. In various embodiments, the contact dielectric bodies 470 are overmolded bodies, which are overmolded over the outer contacts 412. However, the outer contacts 412 may be stitched or otherwise loaded into the contact dielectric bodies 470 in alternative embodiments. The contact dielectric bodies 470 are configured to be coupled to the contact holder 430 to position the outer contact array 416 relative to the contact holder 430.

Each contact 412 includes an intermediate portion 420 extending between a mating end 422 and a terminating end 424. The mating end 422 is configured to be mated to the module circuit board 190 (FIG. 13). In an exemplary embodiment, the contact 412 includes a mating beam 426 at the mating end 422. The mating beam is a deflectable spring beam. However, other types of mating portions may be provided at the mating end, such as pins, contacts, blades, tuning fork contacts, and the like. The terminating end 424 is configured to be terminated to the circuit board 102 (FIG. 1). In an exemplary embodiment, the contact 412 includes a solder tail 428 at the terminating end 424. The solder tail 428 is configured to be soldered to a board pad of the circuit board 102. In the illustrated embodiment, the solder tails 428 include 90° bends to orient the solder tails 428 parallel to the circuit board 102 for connection to the circuit board 102. Other types of terminating portions may be used in alternative embodiments, such as compliant pins, solder pins, spring beams, and the like.

In an exemplary embodiment, the outer contacts 412 are arranged in pairs. For example, the outer contacts 412 may be differential pairs. In alternative embodiments, single outer contacts 412, such as high speed, single-ended contacts, may be arranged in corresponding tracks 444. In an exemplary embodiment, the outer contacts 412 are held in pairs by the corresponding outer contact dielectric bodies 470. The outer contact dielectric bodies 470 encapsulate portions of corresponding pairs of the outer contacts 412. The outer contact dielectric bodies 470 spans across the gaps between the pair of outer contacts 412. The outer contact dielectric bodies 470 are located along sides of the outer contacts 412. The outer contact dielectric bodies 470 are located above and below the outer contacts 412. The outer contact dielectric bodies 470 encapsulate portions of the pairs of the outer contacts 412 to space the outer contacts 412 apart from the central wall 432, the separating walls 442 and the outer shield 600.

Each pair of the outer contacts 412 and the corresponding outer contact dielectric bodies 470 form an outer contact set 417. The outer contact sets 417 are configured to be received in corresponding outer contact tracks 444. The outer separating walls 442 separate adjacent outer contact sets 417 from each other.

In an exemplary embodiment, the outer contact dielectric bodies 470 of each outer contact set 417 are spaced apart from each other. For example, the outer contact dielectric bodies 470 of adjacent outer contact sets 417 are separated by gaps 472, such as air gaps. Optionally, the rows of outer contact dielectric bodies 470 may overmolded as single pieces over the entire leadframe, which are later cut to form the gaps 472 and the separate, individual contact dielectric bodies 470. Alternatively, the outer contact dielectric bodies 470 may be separately molded onto the corresponding pair of outer contacts 412 with the gaps 472 formed during the molding process. In an exemplary embodiment, each outer contact dielectric body only covers a single pair of the outer contacts 412. The gaps 472 are configured to receive the outer separating walls 442. As such, the outer separating walls 442 are configured to be positioned between the outer contact dielectric bodies 470 and between the outer contacts 412 along the outer contact dielectric bodies 470. For example, the intermediate portions 420 of the outer contacts 412 include encapsulated portions 421 (portions encapsulated in the outer contact dielectric bodies 470). The encapsulated portions 421 pass through the outer contact dielectric bodies 470. The outer separating walls 442 are positioned between encapsulated portions 421 of the outer contacts 412 of different outer contact sets 417.

In various embodiments, each outer contact set 417 includes multiple outer contact dielectric bodies 470 supporting the outer contacts 417 at different sections along the lengths of the outer contacts 412. For example, the outer contact dielectric bodies 470 are spaced apart from each other along the lengths. In the illustrated embodiment, each outer contact set 417 includes three of the outer contact dielectric bodies 470 (for example, one proximate to the mating end 422, one proximate to the terminating end 424 and one approximately centered therebetween). Greater or fewer outer contact dielectric bodies 470 may be used in alternative embodiments.

When assembled, the outer contact sets 417 are received in corresponding outer contact tracks 444. The outer contact sets 417 extend along the outer surface 440. The outer contact sets 417 are located between the corresponding outer separating walls 442. The outer contact dielectric bodies 470 are received in the dielectric body pockets 460. The outer separating walls 442 extend along the sides of the outer contact dielectric bodies 470. The dielectric body pockets 460 are sized and shaped to receive the outer contact dielectric bodies 470. For example, the outer contact dielectric bodies 470 may be rectangular shaped and the dielectric body pockets 460 may also be rectangular shaped. The dielectric body pockets 460 may be sized to hold the outer contact dielectric bodies 470 by an interference fit to precisely position the outer contacts 412 relative to the contact holder 430. The outer separating walls 442 are located between outer dielectric body pockets 460 in adjacent outer contact tracks 444 to provide shielding between the outer contact dielectric bodies 470, and thus between the encapsulated portions 421 of the outer contacts 412.

In an exemplary embodiment, the forward-most outer contact dielectric bodies 470 defines front outer contact dielectric bodies 474. The front outer contact dielectric bodies 474 are located in the outer contact tracks 444 proximate to the front end 438. Optionally, the front edge of the front outer contact dielectric bodies 474 may be aligned with the front end 438. The mating beams 426 extending forward of the front outer contact dielectric bodies 474 to mate with a module circuit board 190.

In an exemplary embodiment, the contact assembly 400 includes an outer contact organizer 480 holding all of the outer contacts 412 to position the pairs of the outer contacts 412 relative to each other. In various embodiments, the outer contact organizer 480 is located at the terminating ends 424, such as being connected to the solder tails. In other embodiments, the outer contact organizer 480 may be provided at the end of the intermediate portions of the outer contacts 412. If the outer contact organizer 480 were positioned at an intermediate position, rather than at the ends of the outer contacts 412, there would need to be breaks in the walls 442, which would degrade electrical performance. As such, the outer contact organizer 480 is positioned at the end of the walls 442 rather than in the middle of the walls 442. The outer contact organizer 480 is dielectric. In an exemplary embodiment, the outer contact organizer 480 is overmolded over the leadframe. For example, the outer contact organizer 480 is formed in place on the outer contacts 412. The outer contact organizer 480 is connected to all of the outer contacts 412. The outer contact organizer 480 spaces the outer contacts 412 relative to each other. When assembled, the outer contact organizer 480 is coupled to the outer surface 440 of the contact holder 430. For example, the outer contact organizer 480 may be coupled to the rear wall 434. In various embodiments, the outer contact organizer 480 is located between the outer separating walls 442 and the circuit board bottom end 435. The outer contact organizer 480 may include windows 482 exposing portions of the outer contacts 412.

FIG. 10 is a top view of a portion of the contact assembly 400 in accordance with an exemplary embodiment. FIG. 10 shows the outer contact array 416 coupled to the contact holder 430. The outer contact sets 417 are arranged in corresponding outer contact tracks 444. The outer separating walls 442 are located between the outer contact sets 417. For example, the outer separating walls 442 are located between the outer contact dielectric bodies 470. The outer separating walls 442 are located in the gaps 472 between the outer contact dielectric bodies 470.

In an exemplary embodiment, the mating beams 426 at the mating ends 422 extend forward of the front outer contact dielectric bodies 474. In an exemplary embodiment, ground beams 610 are located between the mating beams 426. The ground beams 610 may be part of the outer shield 600 (FIG. 6).

Returning to FIG. 6, FIG. 6 shows the contact assembly 400 in an assembled state. The outer contacts 412 are located at the outer portion of the contact holder 430 and the inner contacts 414 are located at the inner portion of the contact holder 430. The outer shield 600 is coupled to the outer portion of the contact holder 430. The inner shield 650 is coupled to the inner portion of the contact holder 430. The outer shield 600 provides shielding for the outer contacts 412. The inner shield 650 provides shielding for the inner contacts 414.

The shields 600, 650 may be similar to each other, but may be sized differently to fit on the contact holder 430. In an exemplary embodiment, the outer shield 600 is manufactured from a metal material. For example, the outer shield 600 may be stamped and formed from a metal sheet. The outer shield 600 includes panels 602 extending along the various portions of the contact holder 430, such as along the rear wall 434 and the front wall 436 of the central wall 432. In an exemplary embodiment, the outer shield 600 includes openings 604 in one or more of the panels 602 to couple the outer shield 600 to the contact holder 430. The openings 604 receive the outer mounting posts 446. The outer shield 600 may be press fit to the outer mounting posts 446. In other embodiments, the outer shield 600 may be secured to the outer mounting posts 446 using solder or conductive epoxy. The panels 602 may interface with the distal edges of the outer separating walls 442. Optionally, conductive epoxy or a conductive gasket may be provided between the distal edges of the outer separating walls 442 and the panels 602 of the outer shield 600.

In an exemplary embodiment, the outer shield 600 includes the ground beams 610 extending from the front edge of the outer shield 600. The ground beams 610 are located between corresponding outer contacts 412 (for example, signal contacts). The ground beams 610 provide shielding between the outer contacts 412. For example, the ground beams 610 may be located between the pairs of the outer contacts 412 to provide shielding between the pairs of the outer contacts 412.

In an exemplary embodiment, the outer shield 600 includes the ground tails 620 extending from the rear edge of the outer shield 600. The ground tails 620 are located between corresponding outer contacts 412 (for example, signal contacts). For example, the ground tails 620 may be located between the solder tails 428. The ground tails 620 may be soldered to the circuit board 102 (FIG. 1). The ground tails 620 provide shielding between the outer contacts 412. For example, the ground tails 620 may be located between the pairs of the outer contacts 412 to provide shielding between the pairs of the outer contacts 412.

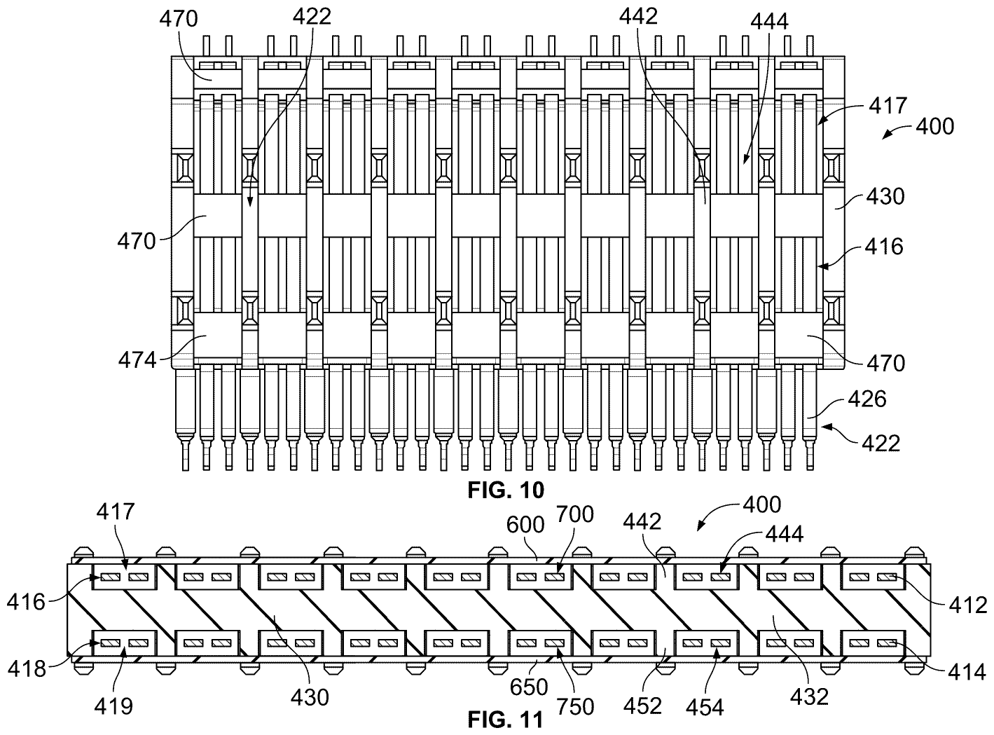

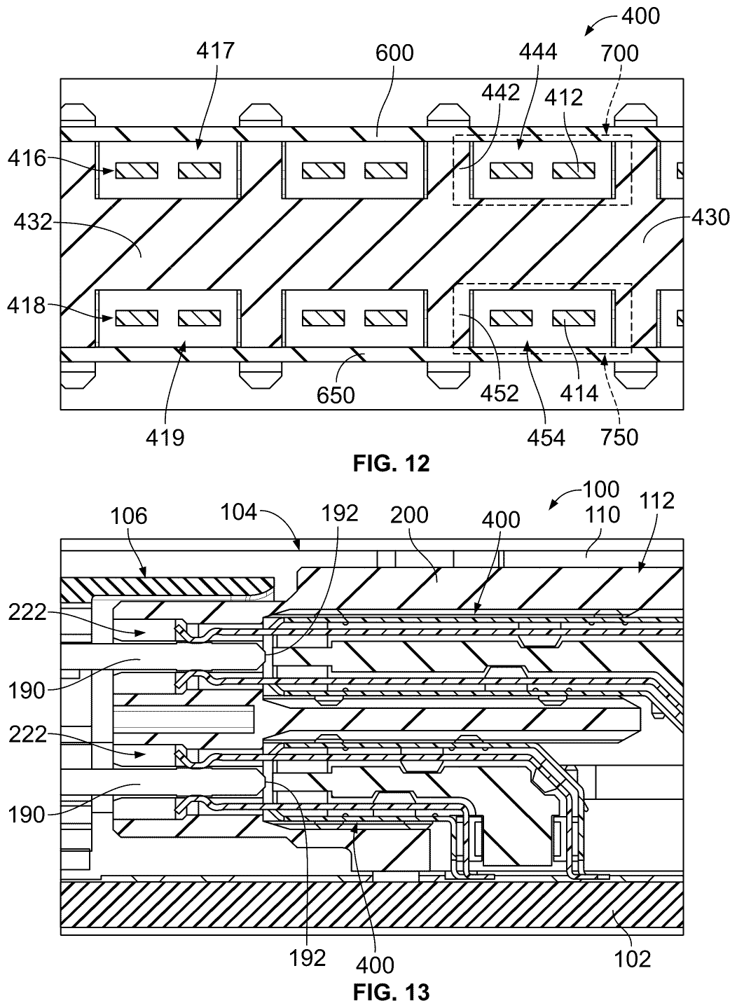

FIG. 11 is a cross sectional view of a portion of the contact assembly 400 in accordance with an exemplary embodiment. FIG. 12 is an enlarged cross-sectional view of a portion of the contact assembly 400 in accordance with an exemplary embodiment. FIGS. 11 and 12 show the contact arrays 416, 418 coupled to the contact holder 430. The outer contact sets 417 are arranged in corresponding outer contact tracks 444. Inner contact sets 419 are arranged in corresponding inner contact tracks 454.

Shielding is provided for the outer and inner contact sets 417, 419. The central wall 432 provides shielding between the outer contacts 412 and the inner contacts 414. The outer separating walls 442 provide shielding between the outer contacts 412 of the adjacent outer contact sets 417. The inner separating walls 452 provide shielding between the inner contacts 414 of the adjacent inner contact sets 419. The outer shield 600 provides shielding outward of the outer contacts 412. The inner shield 650 provides shielding inward of the inner contacts 414. Outer shield pockets 700 are provided for each of the outer contact sets 417. For example, the central wall 432, the separating walls 442, and the outer shield 600 form the outer shield pockets 700 by surrounding the corresponding outer contact tracks 444 to provide circumferential shielding for the corresponding outer contact sets 417. Inner shield pockets 750 are provided for each of the inner contact sets 419. For example, the central wall 432, the separating walls 452, and the inner shield 650 form the inner shield pockets 750 by surrounding the corresponding inner contact tracks 454 to provide circumferential shielding for the corresponding inner contact sets 419.

FIG. 13 is a cross sectional view of a portion of the communication system 100 showing the pluggable module 106 coupled to the receptacle connector assembly 104. FIG. 13 shows the receptacle cage 110 and the electrical connector assembly 112 mounted to the circuit board 102. The pluggable module 106 is coupled to the mating end of the electrical connector assembly 112.

In an exemplary embodiment, the pluggable module 106 includes a pair of the module circuit boards 190. Card edges 192 of the module circuit boards 190 are plugged into the card slots 222 at the front of the housing 200. The mating ends of the contacts extend into the card slots 222 to mate with the module circuit boards 190. The shield structures of the lower and upper contact assemblies 400 provide shielding for the contacts of the lower and upper contact assemblies 400.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A contact assembly comprising:
a contact holder having central wall with an inner surface and an outer surface, the central wall having a front edge between the inner surface and the outer surface, the central wall having a board end between the inner surface and the outer surface configured to face a circuit board, the contact holder including inner separating walls extending from the inner surface of the central wall and defining inner contact tracks along the inner surface, the contact holder including outer separating walls extending from the outer surface of the central wall and defining outer contact tracks along the outer surface, the contact holder being electrically conductive to provide electrical shielding between the inner contact tracks and the outer contact tracks;
an inner contact array coupled to the inner surface of the contact holder, the inner contact array including inner contacts arranged in pairs, the inner contact array including inner contact dielectric bodies encapsulating portions of corresponding pairs of the inner contacts, each pair of the inner contacts and the corresponding inner contact dielectric bodies form an inner contact set, the inner contact dielectric bodies of each inner contact set being spaced apart from each other, the inner contact sets being received in corresponding inner contact tracks with the inner separating walls separating the inner contact sets from other inner contact sets;
an outer contact array coupled to the outer surface of the contact holder, the outer contact array including outer contacts arranged in pairs, the outer contact array including outer contact dielectric bodies encapsulating portions of corresponding pairs of the outer contacts, each pair of the outer contacts and the corresponding outer contact dielectric bodies form an outer contact set, the outer contact dielectric bodies of each outer contact set being spaced apart from each other, the outer contact sets being received in corresponding outer contact tracks with the outer separating walls separating the outer contact sets from other outer contact sets;
an inner shield coupled to the contact holder to cover the inner contact tracks, wherein the central wall, the separating walls, and the inner shield form shield pockets surrounding the corresponding inner contact tracks to provide circumferential shielding for the corresponding inner contact sets; and
an outer shield coupled to the contact holder to cover the outer contact tracks, wherein the central wall, the separating walls, and the outer shield form shield pockets surrounding the corresponding outer contact tracks to provide circumferential shielding for the corresponding outer contact sets.

2. The contact assembly of claim 1, wherein the inner separating walls are continuous from the front edge to a rear of the contact holder, and wherein the outer separating walls are continuous from the front edge to a rear of the contact holder.

3. The contact assembly of claim 1, wherein the inner contact dielectric bodies of adjacent inner contact sets are separated by gaps, the inner separating walls being received in the gaps, and wherein the outer contact dielectric bodies of adjacent outer contact sets are separated by gaps, the outer separating walls being received in the gaps.

4. The contact assembly of claim 1, wherein the inner contacts include encapsulated portions passing through the inner contact dielectric bodies, the inner separating walls positioned between encapsulated portions of the inner contacts of different inner contact sets, and wherein the outer contacts include encapsulated portions passing through the outer contact dielectric bodies, the outer separating walls positioned between encapsulated portions of the outer contacts of different outer contact sets.

5. The contact assembly of claim 1, wherein the inner contact tracks of the contact holder includes inner dielectric body pockets receiving the corresponding inner contact dielectric bodies, the inner separating walls being located between inner dielectric body pockets in adjacent inner contact tracks, and wherein the outer contact tracks of the contact holder includes outer dielectric body pockets receiving the corresponding outer contact dielectric bodies, the outer separating walls being located between outer dielectric body pockets in adjacent outer contact tracks.

6. The contact assembly of claim 1, wherein each inner contact set includes multiple inner contact dielectric bodies, the inner separating walls extending along sides of each of the inner contact dielectric bodies, and wherein each outer contact set includes multiple outer contact dielectric bodies, the inner separating walls extending along sides of each of the outer contact dielectric bodies.

7. The contact assembly of claim 1, wherein the inner contact dielectric bodies encapsulate portions of the pairs of the inner contacts to space the inner contacts apart from the central wall, the separating walls and the inner shield, and wherein the outer contact dielectric bodies encapsulate portions of the pairs of the outer contacts to space the outer contacts apart from the central wall, the separating walls and the outer shield.

8. The contact assembly of claim 1, wherein the inner contact dielectric bodies include front inner contact dielectric bodies located in the inner contact tracks at the front edge, the inner contacts including mating beams extending forward of the front inner contact dielectric bodies to mate with a module circuit board, and wherein the outer contact dielectric bodies include front outer contact dielectric bodies located in the outer contact tracks at the front edge, the outer contacts including mating beams extending forward of the front outer contact dielectric bodies to mate with a module circuit board.

9. The contact assembly of claim 1, wherein the contact assembly includes an inner contact organizer holding all of the inner contacts to position the pairs of the inner contacts relative to each other, the inner contact organizer being dielectric, the inner contact organizer being coupled to the inner surface of the contact holder, the inner contact organizer located between the inner separating walls and the circuit board, and wherein the contact assembly includes an outer contact organizer holding all of the outer contacts to position the pairs of the outer contacts relative to each other, the outer contact organizer being dielectric, the outer contact organizer being coupled to the outer surface of the contact holder, the outer contact organizer located between the outer separating walls and the circuit board.

10. The contact assembly of claim 1, wherein the inner separating walls include inner mounting posts extending therefrom, the inner shield including openings receiving the inner mounting posts, and wherein the outer separating walls include outer mounting posts extending therefrom, the outer shield including openings receiving the outer mounting posts.

11. The contact assembly of claim 1, wherein the inner separating walls extend to inner edges, the inner shield seated on the inner edges of the inner separating walls, and wherein the outer separating walls extend to outer edges, the outer shield seated on the outer edges of the outer separating walls.

12. The contact assembly of claim 1, wherein each inner contact includes an intermediate portion extending between a mating beam and a solder tail, the mating beam configured to be mated to a module circuit board, the solder tail configured to be soldered to the circuit board, the intermediate portions being received in the corresponding shield pockets, and wherein each outer contact includes an intermediate portion extending between a mating beam and a solder tail, the mating beam configured to be mated to a module circuit board, the solder tail configured to be soldered to the circuit board, the intermediate portions being received in the corresponding shield pockets.

13. The contact assembly of claim 12, wherein the inner separating walls extending continuously along the intermediate portions to isolate the intermediate portions from inner contacts in different inner contact tracks, and wherein the outer separating walls extending continuously along the intermediate portions to isolate the intermediate portions from outer contacts in different outer contact tracks.

14. The contact assembly of claim 12, wherein the intermediate portions are shielded on four sides for an entire length of the intermediate portions by the central wall, the corresponding inner separating walls, and the inner shield, and wherein the intermediate portions are shielded on four sides for an entire length of the intermediate portions by the central wall, the corresponding outer separating walls, and the outer shield.

15. A card edge connector for mating with a pluggable module, the card edge connector comprising:
a housing including a top and a bottom, the housing having a front and a rear, the housing having a first side and a second side, the bottom configured to be mounted to a circuit board, the housing including a cavity at the rear, the housing including a card slot open to the cavity at the front of the housing, the card slot configured to receive a card edge of a module circuit board of the pluggable module;
a contact assembly received in the cavity, the contact assembly having a contact holder holding an inner contact array and an outer contact array, the contact array including an inner shield coupled to the contact holder and an outer shield coupled to the contact holder;
the contact holder having central wall with an inner surface and an outer surface, the central wall having a front edge between the inner surface and the outer surface configured to face the card edge of the module circuit board, the central wall having a board end between the inner surface and the outer surface configured to face the circuit board, the contact holder including inner separating walls extending from the inner surface of the central wall and defining inner contact tracks along the inner surface, the contact holder including outer separating walls extending from the outer surface of the central wall and defining outer contact tracks along the outer surface, the contact holder being electrically conductive to provide electrical shielding between the inner contact tracks and the outer contact tracks;
the inner contact array coupled to the inner surface of the contact holder, the inner contact array including inner contacts arranged in pairs, the inner contacts including mating beams extending from the contact holder into the card slot to mate with the module circuit board, the inner contact array including inner contact dielectric bodies encapsulating portions of corresponding pairs of the inner contacts, each pair of the inner contacts and the corresponding inner contact dielectric bodies form an inner contact set, the inner contact dielectric bodies of each inner contact set being spaced apart from each other, the inner contact sets being received in corresponding inner contact tracks with the inner separating walls separating the inner contact sets from other inner contact sets;
the outer contact array coupled to the outer surface of the contact holder, the outer contact array including outer contacts arranged in pairs, the inner contacts including mating beams extending from the contact holder into the card slot to mate with the module circuit board, the outer contact array including outer contact dielectric bodies encapsulating portions of corresponding pairs of the outer contacts, each pair of the outer contacts and the corresponding outer contact dielectric bodies form an outer contact set, the outer contact dielectric bodies of each outer contact set being spaced apart from each other, the outer contact sets being received in corresponding outer contact tracks with the outer separating walls separating the outer contact sets from other outer contact sets;
the inner shield coupled to the contact holder to cover the inner contact tracks, wherein the central wall, the separating walls, and the inner shield form shield pockets surrounding the corresponding inner contact tracks to provide circumferential shielding for the corresponding inner contact sets; and
the outer shield coupled to the contact holder to cover the outer contact tracks, wherein the central wall, the separating walls, and the outer shield form shield pockets surrounding the corresponding outer contact tracks to provide circumferential shielding for the corresponding outer contact sets.

16. The card edge connector of claim 1, wherein the inner separating walls are continuous from the front edge to a rear of the contact holder, and wherein the outer separating walls are continuous from the front edge to a rear of the contact holder.

17. The card edge connector of claim 1, wherein the inner contact dielectric bodies of adjacent inner contact sets are separated by gaps, the inner separating walls being received in the gaps, and wherein the outer contact dielectric bodies of adjacent outer contact sets are separated by gaps, the outer separating walls being received in the gaps.

18. A receptacle connector assembly for connecting a pluggable module with a circuit board, the receptacle connector comprising:
a receptacle cage having walls forming a module channel configured to receive the pluggable module and a port open to the module channel;
a card edge connector configured to be mounted to the circuit board, the card edge connector being received in the module channel for mating with the pluggable module, the card edge connector including a housing and a contact assembly received in the housing:
the housing including a top and a bottom, the housing having a front and a rear, the housing having a first side and a second side, the bottom configured to be mounted to a circuit board, the housing including a cavity at the rear, the housing including a card slot open to the cavity at the front of the housing, the card slot configured to receive a card edge of a module circuit board of the pluggable module;
the contact assembly received in the cavity, the contact assembly having a contact holder holding an inner contact array and an outer contact array, the contact array including an inner shield coupled to the contact holder and an outer shield coupled to the contact holder;
the contact holder having central wall with an inner surface and an outer surface, the central wall having a front edge between the inner surface and the outer surface configured to face the card edge of the module circuit board, the central wall having a board end between the inner surface and the outer surface configured to face the circuit board, the contact holder including inner separating walls extending from the inner surface of the central wall and defining inner contact tracks along the inner surface, the contact holder including outer separating walls extending from the outer surface of the central wall and defining outer contact tracks along the outer surface, the contact holder being electrically conductive to provide electrical shielding between the inner contact tracks and the outer contact tracks;
the inner contact array coupled to the inner surface of the contact holder, the inner contact array including inner contacts arranged in pairs, the inner contacts including mating beams extending from the contact holder into the card slot to mate with the module circuit board, the inner contact array including inner contact dielectric bodies encapsulating portions of corresponding pairs of the inner contacts, each pair of the inner contacts and the corresponding inner contact dielectric bodies form an inner contact set, the inner contact dielectric bodies of each inner contact set being spaced apart from each other, the inner contact sets being received in corresponding inner contact tracks with the inner separating walls separating the inner contact sets from other inner contact sets;
the outer contact array coupled to the outer surface of the contact holder, the outer contact array including outer contacts arranged in pairs, the inner contacts including mating beams extending from the contact holder into the card slot to mate with the module circuit board, the outer contact array including outer contact dielectric bodies encapsulating portions of corresponding pairs of the outer contacts, each pair of the outer contacts and the corresponding outer contact dielectric bodies form an outer contact set, the outer contact dielectric bodies of each outer contact set being spaced apart from each other, the outer contact sets being received in corresponding outer contact tracks with the outer separating walls separating the outer contact sets from other outer contact sets;
the inner shield coupled to the contact holder to cover the inner contact tracks, wherein the central wall, the separating walls, and the inner shield form shield pockets surrounding the corresponding inner contact tracks to provide circumferential shielding for the corresponding inner contact sets; and
the outer shield coupled to the contact holder to cover the outer contact tracks, wherein the central wall, the separating walls, and the outer shield form shield pockets surrounding the corresponding outer contact tracks to provide circumferential shielding for the corresponding outer contact sets.

19. The receptacle connector assembly of claim 1, wherein the inner separating walls are continuous from the front edge to a rear of the contact holder, and wherein the outer separating walls are continuous from the front edge to a rear of the contact holder.

20. The receptacle connector assembly of claim 1, wherein the inner contact dielectric bodies of adjacent inner contact sets are separated by gaps, the inner separating walls being received in the gaps, and wherein the outer contact dielectric bodies of adjacent outer contact sets are separated by gaps, the outer separating walls being received in the gaps.
